(19) United States
(12) Patent Application Publication
(10) Pub. No.: US 2008/0219404 A1
(43) Pub. Date: Sep. 11, 2008

(54) Method and Apparatus to Facilitate Formation of a Two-Dimensional Image Using X-Ray Fan Beam Scatter

(75) Inventor: John F. Moore, Libertyville, IL (US)

Correspondence Address: FITCH EVEN TABIN AND FLANNERY;VARIAN MEDICAL SYSTEMS, 120 SOUTH LASALLE STREET, SUITE 1600, CHICAGO, IL, 60603, US

(73) Assignee: BIO-IMAGING RESEARCH, INC., Lincolnshire, IL (US)

(21) Appl. No.: 11/683,622

(22) Filed: Mar. 8, 2007

(51) Int. Cl. G01N 23/04; G01N 23/20

(52) U.S. Cl. 378/62; 378/87

(57) ABSTRACT

One directs an X-ray fan beam (202) towards a target (205). A first linear array of detectors (207) serve to detect X-ray fan beam scatter (401) as occurs when at least portions of the X-ray fan beam interact with the target. The resultant scatter-based target information is then used to form a two-dimensional view of the target.

### TECHNICAL FIELD

This invention relates generally to imaging systems and more particularly to imaging systems employing X-ray fan beams.

### BACKGROUND

Imaging systems that form images based upon interaction of a target object and X-rays are known. In many cases the formed image relies upon detecting X-rays as pass through the target object. Various materials (and quantities of materials) absorb varying amounts of X-rays as the X-rays pass through the target object and the resultant transmission X-rays as emerge from the target object will exhibit corresponding variations with respect to intensity. These changes in intensity with respect to the initial transmission are used to develop the target object image.

Not all X-ray beams in such a scenario are partially or fully absorbed, however. In many cases some of the X-ray energy is deflected by the target object. Such deflection is commonly referred to as scatter and there can be back scatter, side scatter, and/or forward scatter depending upon the characteristics of the target object itself. Ordinarily the prior art has sought to eliminate scatter as much as possible, partly because scatter can create unwanted radiation exposure to nearby personnel and partly because scatter can create so-called background fog in the resultant image. Such fog can obscure faint objects and detract from image resolution and clarity.

In some cases, however, scatter has been employed in a more positive manner. Proposals exist, for example, to employ back scatter detectors in conjunction with a moving X-ray pencil beam. Such an approach, however, tends towards complexity. Perhaps more significantly, the moving X-ray pencil beam illuminates the target object with an effective duty cycle of only about 1%. As a result, and depending upon the nature of the target object itself, this can result in relatively poor images, or can require either a considerable expenditure of energy and/or time in order to obtain a relatively decent image.

### BRIEF DESCRIPTION OF THE DRAWINGS

The above needs are at least partially met through provision of the method and apparatus to facilitate formation of a two-dimensional image using X-ray fan beam scatter described in the following detailed description, particularly when studied in conjunction with the drawings, wherein:

FIG. 1 comprises a flow diagram as configured in accordance with various embodiments of the invention;

FIG. 2 comprises a perspective schematic view as configured in accordance with various embodiments of the invention;

FIG. 3 comprises a front elevational detail view as configured in accordance with various embodiments of the invention;

FIG. 4 comprises a top plan view as configured in accordance with various embodiments of the invention;

FIG. 5 comprises a top plan view as configured in accordance with various embodiments of the invention;

FIG. 6 comprises a side elevational view as configured in accordance with various embodiments of the invention; and

FIG. 7 comprises a top plan view as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, one directs an X-ray fan beam towards a target. A first linear array of detectors serve to detect X-ray fan beam scatter as occurs when at least portions of the X-ray fan beam interact with the target. The resultant scatter-based target information is then used, in conjunction to with relative motion between then x-ray source and the target, to form a two-dimensional view of the target.

By one approach the linear array of detectors comprises a linear array of back scatter detectors. By another approach the linear array of detectors comprises a linear array of side scatter detectors or forward scatter detectors. If desired, a plurality of such detector arrays can be employed. For example, two linear arrays of back scatter detectors can be deployed with one on either side of the X-ray fan beam. Depending upon the needs and/or requirements of the application setting, these detectors can be placed on the sides of the X-ray fan beam or can be placed above and/or below the X-ray fan beam as well. One may also employ the use of scatter detectors in conjunction with a more traditional transmission detector as well if desired.

The X-ray fan beam offers the advantage of illuminating the target 100% of the time. This contrasts sharply, of course, with a scanning X-ray pencil beam. The resultant structure tends towards relative simplicity. This, in turn, favors both ease of use and maintenance. Such teachings are also readily employed to permit relatively quick and effective scanning of large, difficult targets (such as truck, maritime, and railroad containers and cars).

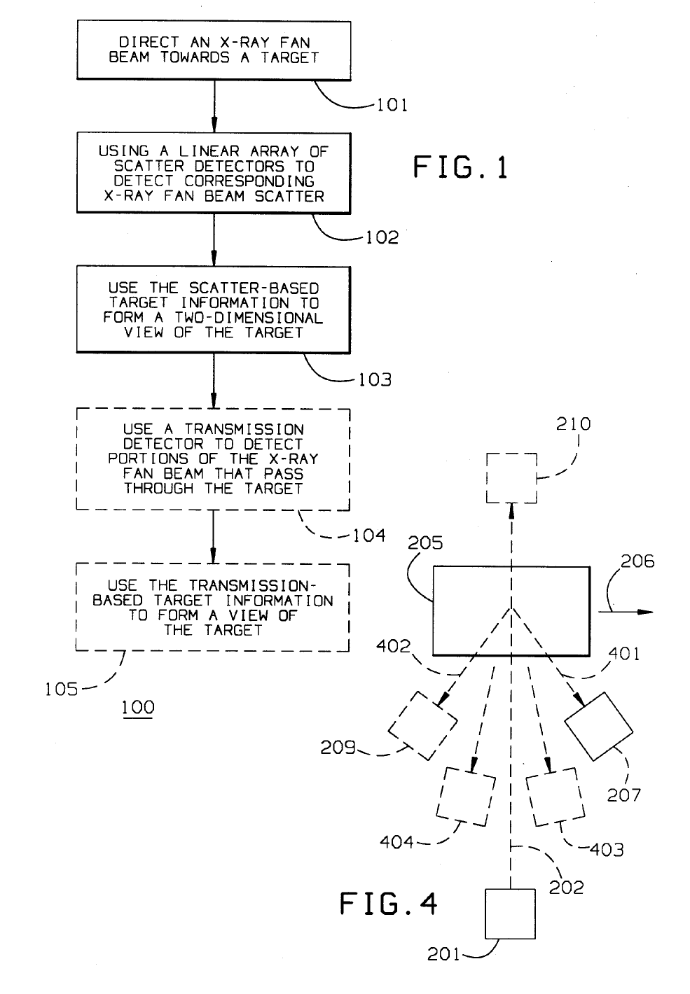

These and other benefits may become clearer upon making a thorough review and study of the following detailed description. Referring now to the drawings, and in particular to FIG. 1, a corresponding process 100 provides for directing 101 an X-ray fan beam towards a target. X-ray sources of various kinds are known in the art and require no specific further elaboration here. The power of the X-ray source can and will vary with respect to the intended application with greater voltage typically being applied when seeking greater penetration capability. These teachings are particularly suitable for use with inspection systems using 2 MV to 9 MV X-ray sources though other voltage levels may also be used if desired.

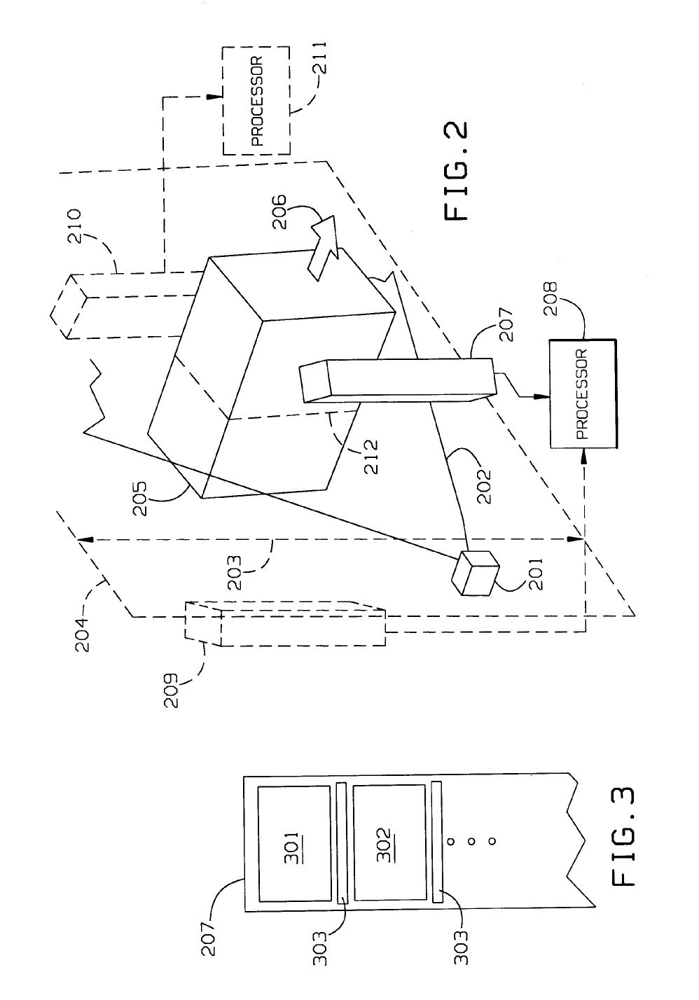

X-ray fan beams are also known in the art. Such beams tend to be wide in a first dimension and relatively narrow in a dimension that is normal to the first dimension. In many prior art applications the wide dimension comprises a horizontally aligned dimension. For these present purposes, however, it may be desirable to orient the X-ray fan beam such that the wide dimension is vertically aligned. With momentary reference to FIG. 2, an X-ray fan beam 202 emanating from a corresponding X-ray fan beam source 201 has a fan-shaped beam pattern that lies substantially within a corresponding plane 204. Various ways are known to form a fan-shaped X-ray beam. In view of this, and further in consideration of the fact that these teachings are not particularly sensitive to the selection of any particular approach in this regard, no further elaboration regarding the formation of an X-ray fan beam need be presented here.

Referring again to FIG. 1, this process 100 then provides for using 102 at least a first linear array of scatter detectors to detect X-ray fan beam scatter as occurs when at least portions of the X-ray fan beam interacts with the target. These scatter detectors provide corresponding scatter-based target information. With momentary reference to FIG. 2, in this illustrative example a first linear array of scatter detectors 207 has been positioned to serve as a back scatter detector, being disposed on the same side of the target 205 as the X-ray source 201.

Those skilled in the art will understand that such a detector effectively serves to convert X-ray photons into electronic signals. There are various ways known in the art by which this may be accomplished including scintillator and direct conversion detectors as are frequently found in modern applications. As such detectors are well known in the art, and further as these teachings are relatively non-dependent upon the use of any particular detection technology or approach, for the sake of brevity further elaboration will not be provided here regarding such detectors.

As shown in the illustrative schematic depiction of FIG. 2, the longitudinal axis of the X-ray responsive face of this first linear array of scatter detectors 207 is aligned substantially parallel to the plane 204 of the X-ray fan beam 202 and more particularly to a long cross-sectional dimension 203 of this plane. This linear array of scatter detectors 207 is also aligned with its X-ray responsive face substantially normal to at least some of the back scatter as will be created through interaction of the target 205 with the X-ray fan beam 202.

By one approach, and referring now momentarily to the schematic representation at FIG. 3, the aforementioned linear array of scatter detectors 207 comprises a plurality of individual scatter detectors 301, 302 that are separated by collimating septa 303 that serve to limit a view of each individual scatter detector to a relatively narrow view of the target. The extent to which these septa 303 extend outwardly from the individual scatter detectors will vary with numerous variables as characterize a given application setting.

So configured, and referring momentarily to FIG. 4, this linear array of scatter detectors 207 is suitably positioned to receive at least some back scatter 401 as occurs through interaction of the X-ray fan beam 202 with the target 205. In many cases, however, it may be desirable to include one or more additional linear arrays of scatter detectors. For example, a second linear array of scatter detectors 209 may optionally be disposed in a manner that is displaced from the first linear array of scatter detectors 207. In this illustrative example provided, a second linear array of scatter detectors 209 is horizontally displaced from the first linear array of scatter detectors 207 on an opposing side of the X-ray fan beam 202.

So configured, this second linear array of scatter detectors 209 is suitably positioned to also receive at least some back scatter 402 as occurs through interaction of the X-ray fan beam 202 with the target 205. As with the first linear array of scatter detectors 207, it may be useful to orient the longitudinal axis of the second linear array of scatter detectors 209 substantially parallel to the X-ray fan beam plane 204 and with its x-ray sensitive face substantially normal to at least some of the back scatter 402.

As will be discussed below in more detail, additional linear arrays of scatter detectors and/or alternative placements are possible and may be used as appropriate to suit the needs and/or requirements of a given application.

Referring again to FIG. 1, this process 100 then provides for using 103 the scatter-based target information to form a two-dimensional view of the target. Referring again to FIG. 2, the X-ray fan beam 202 illuminates a relatively thin slice 212 of the target 205 at any given time. By moving 206 the target 205 with respect to the X-ray fan beam 202 complete illumination over time of the target 205 can be achieved. This can be accomplished in any of a variety of ways as will be understood by the skilled artisan. For example, the X-ray source 201 can be caused to move, the target 205 can be caused to move, or both the X-ray source 201 and the target 205 can be caused to move to effect the desired relative movement described above.

A processor 208 of choice can receive the scatter-based target information from the linear array of scatter detectors 207 (and 209 when present). Such processors are known in the art and serve to collect and process target information as corresponds to a plurality of individual views to thereby form an aggregate two-dimensional view of the target. Such a two-dimensional view can be provided to a user, for example, using a display technology of choice (not shown). Such views can also be stored, transmitted to a remote location, and/or printed if desired.

Referring again to FIG. 1, this process 100 is compatible for use in conjunction with more traditional transmission detectors as well if desired. In particular, this process 100 can further accommodate using 104 a transmission detector array to detect portions of the X-ray fan beam as pass through the target and the resultant transmission-based target information can then be used 105 to form a view of the target. To illustrate, and referring again to FIG. 2, a standard transmission detector array 210 can be disposed behind the target 205 in line with the X-ray fan beam 202. A processor 211 can operably couple to the transmission detector array 210 to facilitate receiving and processing the transmission-based target information to form the corresponding image.

If desired, the latter processor 211 can comprise the same processor 208 as processes the scatter-based target information. Also if desired, the resultant images from the two processors 208 and 211 can be combined into an aggregate image or can be used as independent views of the same target 205.

As noted earlier, there are various alterations that one may introduce with respect to these teachings. To illustrate, and referring now to FIG. 4, this top plan schematic view further illustrates that additional linear arrays of scatter detectors 403 and 404 may be deployed as additional back scatter detectors if desired. Such a configuration may be useful to accommodate targets having unique shapes and/or materials and/or to accommodate particular working environment constraints or opportunities.

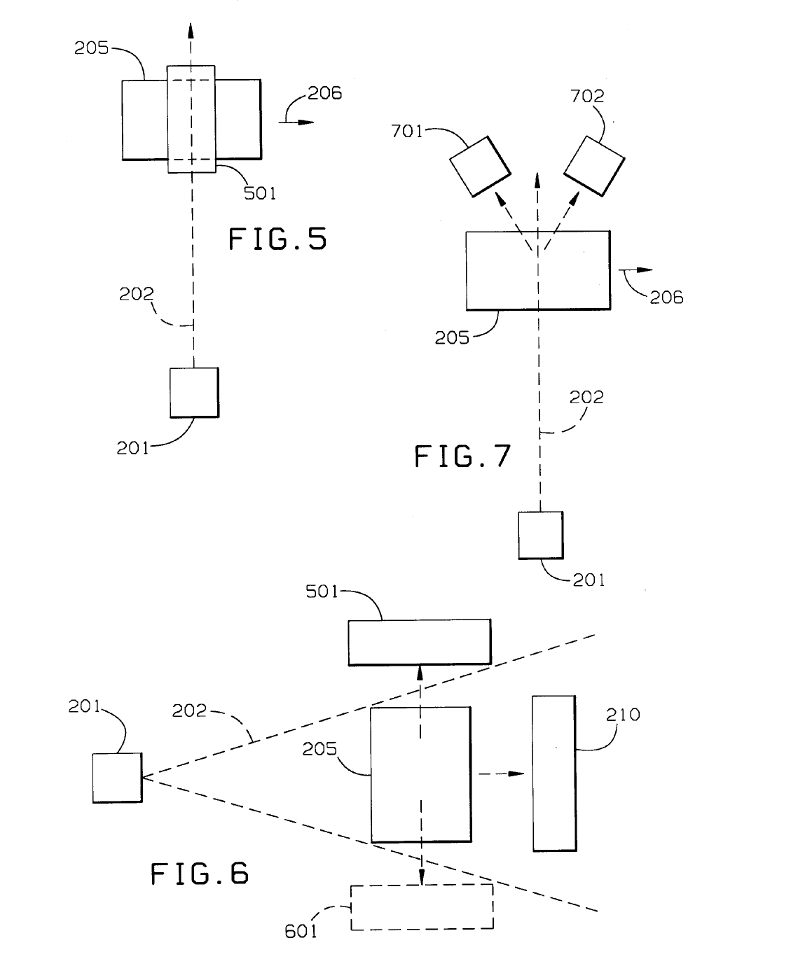

As another illustrative example, and referring now to FIGS. 5 and 6, a linear array of detectors 501 can be deployed to serve as a side scatter detector beneath or above the X-ray fan beam 202. If desired, a second side scatter detector 601 can be disposed on an opposing side of the target 205 to thereby provide two side scatter detectors. Side scatter detection may be used, for example, to accommodate a setting where little lateral space is available for back scatter detectors but where room exists above and/or below the X-ray fan beam 202 to accommodate such detectors. Or, if desired, side scatter detection can be employed in conjunction with simultaneous back scatter and/or forward scatter detection. For most purposes, however, using side scatter detectors alone should be sufficient (particularly when used with a transmission detector 210).

As yet another illustrative example, and referring now to FIG. 7, one or more linear arrays of detectors 701 and 702 may be deployed behind the target 205 to thereby detect forward scatter as can occur through interaction of the X-ray fan beam 202 with the target 205. It will be well understood that these teachings can readily comprise any combination of the above-described detector locations.

Those skilled in the art will appreciate that when one set of scatter detectors is placed on either side of the plane of the X-ray fan beam and also above (or below) the X-ray fan beam, then it is possible to obtain, presuming target motion, three-dimensional information regarding the target (such as, for example, three-dimensional information regarding the relative position of one or more objects within a cargo container). As the target moves a first linear array of side scatter detectors disposed above or below the X-ray fan beam provides a corresponding two-dimensional view from above or below the X-ray fan beam. Additional detectors (such as back scatter, side scatter, and/or forward scatter detectors) that are aligned normal to the direction of propagation of the target can then provide vertical position information regarding scattered target. Together these two two-dimensional views provide three-dimensional information (though not necessarily a three-dimensional image) regarding the target. Such three-dimensional information can also be similarly attained by using side scatter detectors as disclosed above in conjunction with a transmission detector.

These teachings are well suited to megavolt systems intended for use with large scale inspection systems such as cargo inspection systems. In comparison with back scatter at several hundred kilovolts, it has been noted that back scatter coefficients are often eight to ten times lower in the megavolt region. This, however, is substantially offset by the latter's higher photon rates. Further, the voltage of the back scatter near 180 degrees from 200 kV to 450 kV sources is near 100 kV, while that from megavolt sources is over 200 kV. Accordingly, the higher-voltage back scatter from megavolt sources can emerge from greater depths. This, in turn, can comprise an important advantage for larger or denser targets. Much the same applies to side scatter near 90 degrees, where the scattered energy from 200 kV to 450 kV sources is mostly below 200 kV while that from megavolt sources is over 400 kV.

These teachings offer considerable benefit when employed in conjunction with a security-based inspection system. Traditional transmission detection, for example, cannot readily discern the difference between a relatively low-density object that is thick and a relatively high density object that is thinner. The resulting image will typically look the same for both as both can absorb the same amount of total X-ray intensity. Some materials of concern, however, such as many explosives, tend to exhibit relatively high scatter coefficients. Consequently, although a certain quantity, and/or thickness shape, of explosive material may look identical to a lump of steel of different quantity, shape and/or thickness when viewed using transmission detection, the two objects will look considerably different from one another when viewed using scatter-based detection.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. For example, in the illustrative examples offered above, the detectors have a substantially rectangular-shaped cross-sectional form factor. For at least some applications, however, it may be desirable to use a wedge-shaped cross-sectional form factor instead.

We claim:

1. A method comprising:
directing an X-ray fan beam having a corresponding plane towards a target;
using at least a first linear array of scatter detectors to detect X-ray fan beam scatter as occurs when at least portions of the X-ray fan beam interact with the target to provide scatter-based target information;
using the scatter-based target information to form a two-dimensional view of the target.

2. The method of claim 1 wherein the linear array of scatter detectors is aligned substantially parallel to the plane of the X-ray fan beam.

3. The method of claim 2 wherein the linear array of scatter detectors is aligned substantially parallel to the plane of the X-ray fan beam and substantially parallel to a long cross-sectional dimension of the plane of the X-ray fan beam.

4. The method of claim 2 wherein the linear array of scatter detectors is aligned substantially parallel to the plane of the X-ray fan beam and substantially normal to a long cross-sectional dimension of the plane of the X-ray fan beam.

5. The method of claim 1 wherein using at least a first linear array of scatter detectors further comprises using a plurality of individual scatter detectors that are separated from each other by collimating septa that limit a view of each individual scatter detector to a narrow region of the target.

6. The method of claim 1 wherein using at least a first linear array of scatter detectors further comprises using at least a second linear array of scatter detectors, which second linear array of scatter detectors is displaced from the first linear array of scatter detectors.

7. The method of claim 6 wherein the second linear array of scatter detectors is horizontally displaced from the first linear array of scatter detectors on an opposing side of the X-ray fan beam.

8. The method of claim 6 wherein the second linear array of scatter detectors is placed substantially parallel to the plane of the X-ray fan beam.

9. The method of claim 1 further comprising:
using a transmission detector to detect at least portions of the X-ray fan beam as pass through the target to provide transmission-based target information.

10. The method of claim 9 further comprising:
using the transmission-based target information to form a view of the target.

11. The method of claim 1 wherein using at least a first linear array of scatter detectors comprises using, at least in part, scatter detectors having an X-ray responsive face that is oriented substantially normal to at least some of the X-ray fan beam scatter.

12. An X-ray apparatus comprising:
an X-ray fan beam source configured and arranged to direct an X-ray fan beam having a corresponding plane towards a target;
a first linear array of scatter detectors configured and arranged to detect X-ray fan beam scatter as occurs when at least portions of the X-ray fan beam interact with the target and having an output providing scatter-based target information;
a processor having an input coupled to receive the scatter-based target information and being configured and arranged to use the scatter-based target information in combination with information regarding relative motion between the target and the plane of the x-ray fan beam to form a two-dimensional view of the target.

13. The X-ray apparatus of claim 12 wherein the first linear array of scatter detectors is aligned substantially parallel to the plane of the X-ray fan beam.

14. The X-ray apparatus of claim 13 wherein the first linear array of scatter detectors is aligned substantially parallel to the plane of the X-ray fan beam and substantially parallel to a long cross-sectional dimension of the X-ray fan beam at right angles to a direction of propagation.

15. The X-ray apparatus of 13 wherein the first linear array of scatter detectors is aligned substantially parallel to the plane of the X-ray fan beam and substantially normal to a long cross-sectional dimension of the X-ray fan beam at right angles to a direction of propagation.

16. The X-ray apparatus of claim 12 wherein the first linear array of scatter detectors further comprises a plurality of individual scatter detectors that are separated from each other by collimating septa that limit a view of each individual scatter detector to a narrow region of the target.

17. The X-ray apparatus of claim 12 further comprising at least a second linear array of scatter detectors, which second linear array of scatter detectors are displaced from the first linear array of scatter detectors.

18. The X-ray apparatus of claim 17 wherein the second linear array of scatter detectors are horizontally displaced from the first linear array of scatter detectors on an opposing side of the X-ray fan beam.

19. The X-ray apparatus of claim 18 wherein the second linear array of scatter detectors is placed substantially parallel to the plane of the X-ray fan beam.

20. The X-ray apparatus of claim 12 further comprising:
a transmission detector to detect at least portions of the X-ray fan beam as pass through the target to provide transmission-based target information.

21. The X-ray apparatus of claim 20 further comprising:
a second processor operably coupled to receive the transmission-based target information and being configured and arranged to use the transmission-based target information to form a view of the target.

22. The X-ray apparatus of claim 12 wherein the first linear array of scatter detectors each have an X-ray responsive face that is oriented substantially normal to at least some of the X-ray fan beam scatter.

23. The X-ray apparatus of claim 12 wherein the first linear array of scatter detectors comprise means for detecting X-ray scatter.

24. The X-ray apparatus of claim 12 wherein the processor comprises means for forming a two-dimensional view of the target.

25. A method of facilitating provision of an X-ray-based image of a target comprising:
directing an X-ray fan beam having a corresponding plane towards the target;
using at least a first linear array of scatter detectors to detect X-ray fan beam scatter as occurs when at least portions of the X-ray fan beam interact with the target to provide scatter-based target information;
using at least a second linear array of scatter detectors, which second linear array of scatter detectors are horizontally displaced from the first linear array of scatter detectors, to provide additional scatter-based target information;
using the scatter-based target information and the additional scatter-based target information in combination with relative motion between the target and the plane of the x-ray fan beam to form at least one two-dimensional view of the target.

26. The method of claim 25 wherein the second linear array of scatter detectors are horizontally displaced from the first linear array of scatter detectors on an opposing side of the X-ray fan beam.

27. The method of claim 25 further comprising:
using a transmission detector to detect at least portions of the X-ray fan beam as pass through the target to provide transmission-based target information.
